(19) United States
(12) Patent Application Publication
(10) Pub. No.: US 2015/0339744 A1
(43) Pub. Date: Nov. 26, 2015

(54) SYSTEMS AND METHODS FOR REQUESTING A QUOTE OR PROCESSING AN ORDER

(71) Applicants: Christine GESEK, (US); Paul Barry RICHES, (US); Richard STANARD, (US)

(72) Inventors: Christine Jaffarian, Worcester, MA (US); Paul Barry Riches, Paxton, MA (US); Richard W. Stanard, JR., Charlton, MA (US)

(21) Appl. No.: 14/653,083

(22) PCT Filed: Jan. 9, 2013
(86) PCT No.: PCT/US13/20791

§ 371 Date: Jun. 17, 2015

(51) Int. Cl. G06Q 30/06

(52) U.S. Cl. CPC G06Q 30/0611; G06Q 30/0643; G06Q 30/0633

(57) ABSTRACT

A system is adapted to request or quote or process an item order request. The system comprises a first database stored with drawings of at least one machine; a second database stored with customer data; and a user interface providing access to the first database adapted for a user to select from a drawing an item to be ordered and then providing access to the second database to either store or select customer data.

### BACKGROUND

1. Field of the Invention

Aspects of the present invention relate to a quoting/ordering system and, more particularly, to a remote quoting/ordering system for spares in a metals mill, whereby the remote quoting/ordering system being adapted to be controlled via a handheld device.

2. Description of Related Art

Currently, requesting a quote or ordering spares for a machine in a rolling mill, such as a long rolling or flat rolling mill, includes completing a form and submitting the quote/order via facsimile or e-mail, or orally over a phone call. In order to properly request a quote or order the right item or spare part, a copy of the drawings for the machine is often necessary. Oftentimes, the wrong part is quoted or ordered usually because the part number sought is transcribed improperly or distorted in transmission.

An improved ordering system and method are desired.

### SUMMARY

Briefly described, aspects of the present invention relate to a system adapted to request or quote or process an item order request. The system comprises a first database stored with drawings of at least one machine; a second database stored with customer data; and a user interface providing access to the first database adapted for a user to select from a drawing an item to be ordered and then providing access to the second database to either store or select customer data.

To the accomplishment of the foregoing and related ends, the following description and annexed drawings set forth in detail certain illustrative aspects and implementations of the invention. These are indicative of but a few of the various ways in which the principles of the invention may be employed. Other aspects, advantages, and novel features of the invention will become apparent from the following detailed description of the invention when considered in conjunction with the drawings.

### BRIEF DESCRIPTION OF THE DRAWINGS

FIG. 1 is a block diagram representation of a computing environment and computer systems thereof in which an ordering system of the present invention may utilize, in accordance with an exemplary embodiment of the present invention.

FIG. 2 is a graphical representation of first screen shot, a HOME screen, of the ordering system, in accordance with an exemplary embodiment of the present invention.

FIG. 3 is a graphical representation of a second screen shot, a CUSTOMER screen, of the ordering system, in accordance with an exemplary embodiment of the present invention.

FIG. 4 is a graphical representation of a third screen shot, a QUOTE/ORDER screen, of the ordering system, in accordance with an exemplary embodiment of the present invention.

FIG. 5 is a graphical representation of a fourth screen shot, a SCAN view screen, of the ordering system, in accordance with an exemplary embodiment of the present invention.

FIG. 6 is a graphical representation of a fifth screen shot, a HELP screen, of the ordering system, in accordance with an exemplary embodiment of the present invention.

FIG. 7 is a graphical representation of a sixth screen shot, an UPDATE LICENSE screen, of the ordering system, in accordance with an exemplary embodiment of the present invention.

### DETAILED DESCRIPTION

To facilitate an understanding of embodiments, principles, and features of the present invention, they are explained hereinafter with reference to implementation in illustrative embodiments. In particular, they are described in the context of being a quoting/ordering system for spares in a mill. Embodiments of the present invention, however, are not limited to use in the described systems.

The components and materials described hereinafter as making up the various embodiments are intended to be illustrative and not restrictive. Many suitable components and materials that would perform the same or a similar function as the materials described herein are intended to be embraced within the scope of embodiments of the present invention.

In an exemplary embodiment, aspects of the present invention relate to a mobile application provided on a handheld device, such as a Smartphone, tablet, or like device, that permits a user to walk freely without wired tethering. In an alternative embodiment, a hands-free device can be used in aspects of the present invention. The mobile application is adapted to display drawings of a machine and communicate a request for parts to quote or order.

In an exemplary embodiment, the quoting/ordering system (although referred to herein, oftentimes, for simplicity, as the “ordering system” one skilled in the art would appreciate that aspects of the ordering system can also be used as a quoting system) comprises a first database stored with drawings of at least one machine; a second database storable with customer data; and a user interface providing access to the first database adapted for a user to select from a drawing an item to be ordered, and then providing access to the second database to either store or select customer data.

In aspects of the present invention, the term machine as used herein may refer to multi-part systems. In an exemplary embodiment, for example a long rolling mill, “machine” may refer to many parts of a roughing mill, intermediate mill, or finishing mill. In a long rolling mill example, “machine” may further refer to, for example and without limitation, a rolling stand, a water box, reducing sizing mill, laying head system, cooling conveyor, coil handling system, coil compactor, bar bundling system, cooling bed system, and the like.

A feature of the ordering system can be that it may operate with an expiring license. For example, none of the drawings may be shown if there is not a valid license between the spare part provider—which may or may not be the manufacturer—and the customer. In other words, without a valid, current license, the applicable drawings can be prevented from being be displayed, i.e., blocked.

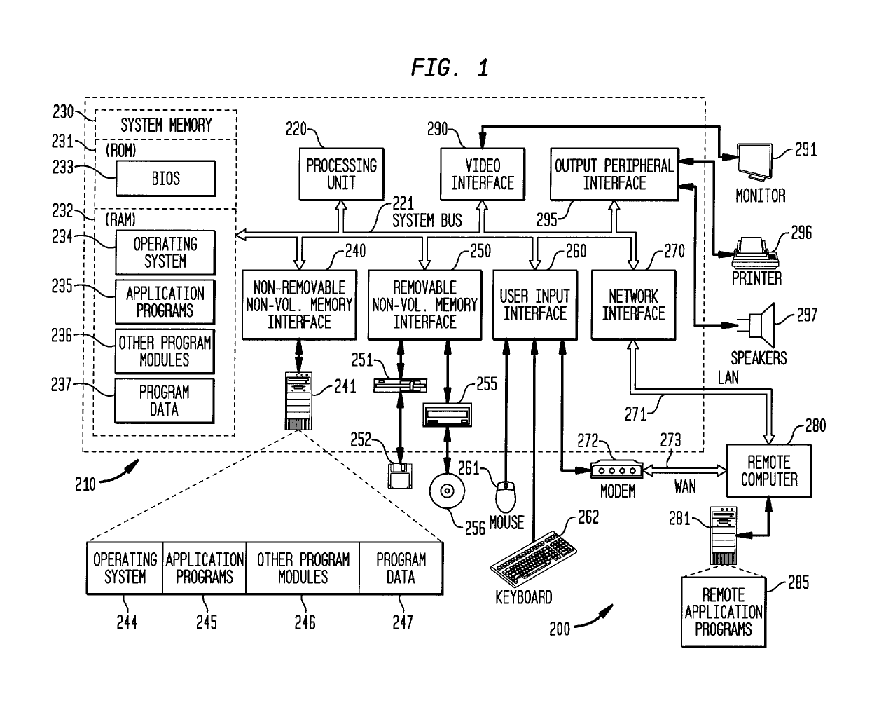

Referring now to FIG. 1, it displays a block diagram representation of a computing environment 200 and computer systems 210, 280 thereof in which an ordering system may utilize, in accordance with an exemplary embodiment of the present invention. The computing environment 200 and the computer systems 210, 280 represent one example of a suitable computing environment and computer systems for the practice of embodiments of the present invention and are not intended to suggest any limitation as to the scope of use or functionality of the invention. Nor should the computer systems 210, 280 be interpreted as having dependency or requirement relating to the combination of components illustrated in the exemplary computing environment 200.

Embodiments of the present invention are operational with numerous other general purposes or special purposes computing system environments or configurations. Examples of well-known computing systems, environments, and/or configurations that may be appropriate or suitable for use as client systems include, but are not limited to, personal computers, server computers, hand-held or laptop devices, tablets, smart phones, multiprocessor systems, microprocessor-based systems, set top boxes, programmable consumer electronics, network PCs, minicomputers, mainframe computers, distributed computing environments that include portions of the above systems or devices, and the like.

Embodiments of the present invention may also be described in the general context of comprising computer-executable instructions, such as program modules, being executed by a computer system. Generally, program modules include routines, programs, programming, objects, components, data, data structures, and the like that perform particular tasks or implement particular abstract data types. Embodiments of the present invention may be practiced in distributed computing environments where tasks are performed by remote processing devices that are linked through a communications network. In a distributed computing environment, program modules may be located in both local and remote computer storage media, including, without limitation, in memory storage devices.

Exemplary client systems, telephony home servers, and proxy servers may comprise general purpose computing devices in the form of the computer system 210, as illustrated in FIG. 1. Components of the computer system 210 may include, but are not limited to, a processing unit 220, a system memory 230, and a system bus 221 that couples various system components including the system memory 230 to the processing unit 220 for bi-directional data and/or instruction communication. The system bus 221 may be many of several types of bus structures including a memory bus or memory controller, a peripheral bus, and a local bus using any of a variety of bus architectures. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (i.e., also known as the “Mezzanine bus”).

The computer system 210 can include and interact with a variety of computer-readable media. The computer-readable media may comprise many available media that can be accessed by, read from, or written to by the computer system 210 and may include both volatile and nonvolatile, removable, and non-removable media. For example and not limitation, computer-readable media may comprise computer storage media and communication media. Computer storage media includes volatile and nonvolatile, removable, and non-removable media implemented in many methods or technologies for storage of information such as computer-readable instructions, data, data structures, program modules, programs, programming, or routines. Computer storage media includes, but is not limited to, RAM, ROM, EEPROM, flash memory or other memory technology, CD-ROM, digital versatile disks (DVD) or other optical disk storage, magnetic cassettes, magnetic tape, magneto-optical storage devices, magnetic disk storage or other magnetic storage devices, or other media that can be used to store the desired information and may be accessed by computer system 210. Communication media typically embodies computer-readable instructions, data, data structures, program modules, programs, programming, or routines in a modulated data signal, such as a carrier wave or other transport mechanism and includes any information delivery media. The term “modulated data signal” means a signal that has one or more of its characteristics set or changed in such a manner as to encode information in the signal. For example and not limitation, communication media includes wired media such as a wired network or direct-wired connection, and wireless media such as acoustic, RF, infrared and other wireless media. Various combinations of the above are also included within the scope of computer-readable media.

The system memory 230 may include computer storage media in the form of volatile and/or nonvolatile memory such as read only memory (ROM) 231 and random access memory (RAM) 232. A basic input/output system 233 (BIOS), containing the basic routines that direct the transfer of information between elements within the computer system 210, such as during start-up, is typically stored in ROM 231. RAM 232 typically stores data and/or program instructions that are immediately accessible to and/or presently being operated on by the processing unit 220. By way of example, and not limitation, FIG. 1 illustrates an operating system 234, application programs 235, other program modules 236, and a program data 237, which may be resident in RAM 232, in whole or in part, from time-to-time.

The computer system 210 may also include other removable/non-removable, volatile/nonvolatile computer storage media. By way of example only, FIG. 1 illustrates a hard disk drive 241 that reads from or writes to non-removable, nonvolatile magnetic media, a magnetic disk drive 251 that reads from or writes to a removable, nonvolatile magnetic disk 252, and an optical disk drive 255 that reads from or writes to a removable, nonvolatile optical disk 256 such as a CD ROM or other optical media. Other removable/non-removable, volatile/nonvolatile computer storage media that may be included in the exemplary computing environment 200 include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 251 and optical disk drive 255 are typically connected to the system bus 221 by a removable memory interface, such as interface 250.

The drives 241, 251, 255 and their associated computer storage media discussed above provide storage of computer-readable instructions, data, data structures, program modules, programs, programming, or routines for computer system 210. For example, the hard disk drive 241 stores operating system 244, application programs 245, other program modules 246, and program data 247. These components may either be the same as or different from operating system 234, application programs 235, other program modules 236, and program data 237. The operating system 244, application programs 245, other program modules 246, and program data 247 are given different numbers to illustrate that, at a minimum, they are different copies of operating system 234, application programs 235, other program modules 236, and program data 237. A user may enter commands and information into computer system 210 through connected input devices, such as a keyboard 262 and pointing device 261, commonly referred to as a mouse, trackball or touch pad. Other connected input devices (not shown) may include a microphone, joystick, game pad, satellite dish, scanner, or the like. These and other input devices are often connected to the processing unit 220 through a user input interface 260 that is coupled to the system bus 221, but may be connected by other interface and bus structures, such as a parallel port, game port or a universal serial bus (USB). A monitor 291 or other type of display device may be also connected to the system bus 221 via an interface, such as a video interface 290. In addition to the monitor 291, the computer system 210 may also include other peripheral output devices such as speakers 297 and printer 296, which may be connected through an output peripheral interface 295.

The computer system 210 may operate in a networked environment using bi-directional communication connection links to one or more remote computer systems, such as a remote computer system 280. The remote computer system 280 may be a tablet, Smartphone, personal computer, a laptop computer, a server computer, a router, a network PC, a peer device, or other common network node, and typically includes many or all of the elements described above relative to the computer system 210, although only a memory storage device 281 of the remote computer system 280 has been illustrated in FIG. 1. The bi-directional communication connection links depicted in FIG. 1 include a local area network (LAN) 271 and a wide area network (WAN) 273, but may also include other networks. Such networks are commonplace in offices, enterprise-wide computer networks, intranets, and the Internet. In a preferred embodiment, aspects of the present invention can include a hand-held device (e.g., tablet or Smartphone) with storage and wireless capability, meaning it can communication via a wireless communication system, including but not limited to 1G, 2G, 3G, 4G and other cellular communication systems, but also Wi-Fi and the like.

When communicatively connected to a LAN 271, the computer system 210 connects to the LAN 271 through a network interface or adapter 270. When communicatively connected to a WAN 273, the computer system 210 typically includes a modem 272 or other means for establishing a communication link over the WAN 273, such as the Internet. The communication system, or modem 272, which may be internal or external, may be connected to the system bus 221 via the user input interface 260, or other appropriate mechanism. In a networked environment, program modules depicted relative to the computer system 210, or portions thereof, may be stored in the remote memory storage device 281. By way of example, and not limitation, FIG. 1 illustrates remote application programs 285 as residing in memory storage device 281. The network connections shown are exemplary and other means of establishing a bi-directional communication link between the computers may be used.

In an exemplary embodiment, the ordering system and method can operate on the computer system 210, and can be stored on a medium or media part of, in communication with, and/or connected to the computer system 210. In an exemplary embodiment, the energy decision ordering system can be developed in a programming language, for example and not limitation C, C++, Java, Assembly, COBOL, and the like. In an alternative embodiment, the ordering system can be developed atop a software program, for example and not limitation, LOTUS, Microsoft Excel, and other spreadsheet-like applications.

In an exemplary embodiment, the ordering system is a mobile application provided on a hand-held device, which may preferably be a tablet, enabling a user to walk through a plant, such as a long rolling mill, display machine or equipment drawings, and add parts/items/spare parts to a request for a quote or order parts. The ordering system comprises a program; a first database stored with drawings of at least one machine; a second database storable with customer data; and a user interface providing access to the first database adapted for a user to select from a drawing an item to be ordered and then providing access to the second database to either store or select customer data.

The mobile application may include a HOME screen 400. In an exemplary embodiment, the HOME screen 400 may have a plurality of panels. For example, the HOME screen may include three panels, each of which can provide a variety of functionality based on the functionality the user has navigated. In an exemplary embodiment, when the program/mobile application is initially opened by selecting an initial icon in the Applications screen, an upper panel 402 is where the current drawing (when first opened this is the top level drawing) can be displayed, a bottom panel 404 may provide navigation buttons to get to other functionality in the program, and a side panel 406 may display the bill of materials for the currently displayed drawing. Other arrangements different from these are contemplated and possible.

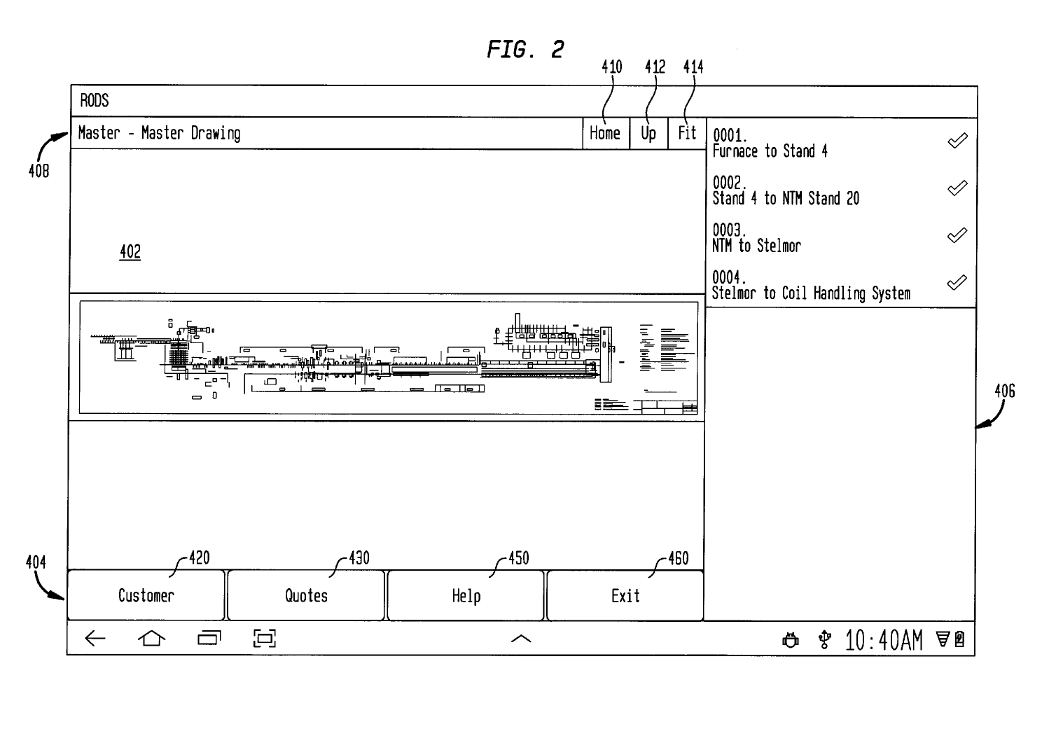

In this example and arrangement, the upper panel 402 can provide different functionality based on what the user has selected. When the program first opens (see FIG. 2), this panel 402 can display drawings of the machine. When in drawing mode, the main area of this panel can display the drawing. The title bar of the drawing view can display the part number and description of the current drawing. There can also be a plurality buttons in the title bar 408 of this panel—e.g., “Home,” “Up,” and “Fit.” (“Buttons,” as used herein, generally refer to icons for selection, which may be selected in the touch screen embodiment by touching the icon). The “Home” button 410 can allow the user to quickly return to the top level drawing. The “Up” button 412 can display the drawing that is up one level in the bill of materials from the currently displayed drawing. The “Fit” button 414 can reset the current drawing to fit to the view. In exemplary embodiments, for example in a tablet or touch screen device, the user may use the two-finger pinch method to zoom-in and zoom-out on a drawing, and while zoomed can drag the drawing around the view. The “Fit” button 414 can reset back to the initial view of the drawing. The drawing view preferably displays a single sheet of a drawing at a time, so if the drawing has more than one sheet, the user can tap the right or left edge of the drawing to flip forward or backwards through the sheets of the drawing. To drill down through the drawings from the top level (e.g., mill layout) drawing, the user can tap on the drawing in the area of the mill they want to zoom. Once at the equipment level of drawings they may use the bill of materials to select the drawing to display. To select a drawing from the bill of materials (from any level of drawing) the user can tap once on the desired item in the bill of materials, so that it is highlighted, and then swipe the item and the drawing can be displayed. To navigate back up one level they can use the “Up” button 412, or use the “Home” button 410 to go directly back to the mill layout drawing. If the drawing is changed, the right side panel of the main screen may update to show the bill of materials for the currently displayed drawing.

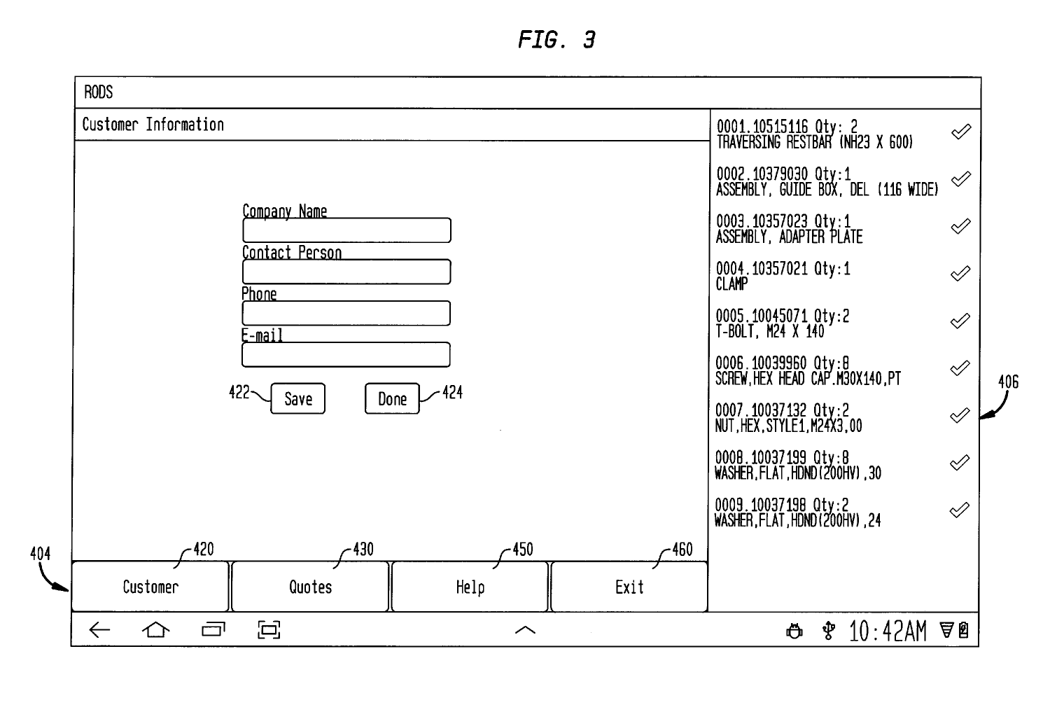

Continuing in this arrangement, the lower panel 404 of the main screen can offer navigation buttons to go to other functionality of the program. The “Customer” button 420 can change the upper left panel from a drawing view to a customer information view (see FIG. 3). Here, the user can enter the various characteristics of the customer, including without limitation: “Company Name,” “Contact Person,” and Contact Information, such as “Phone” and “E-mail Address.” Below the customer information view can be a plurality of buttons, for example and not limitation, “Save” 422 and “Done” 424. When the user selects “Save” 422, the customer data can be saved to the second database that can be stored on the device, again for example a mobile device, such as a tablet or Smartphone. The next time the user enters this view, the saved data can be pre-populated in the appropriate fields. The “Done” button 424 can permit the user to exit the customer data screen and return to the drawing view.

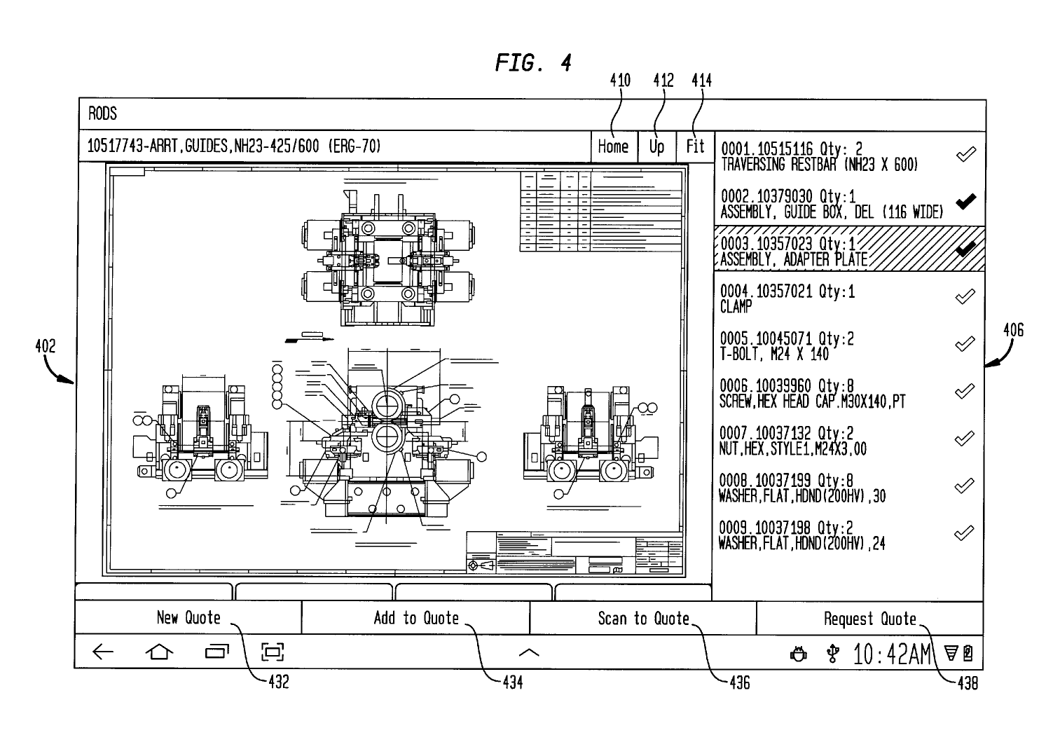

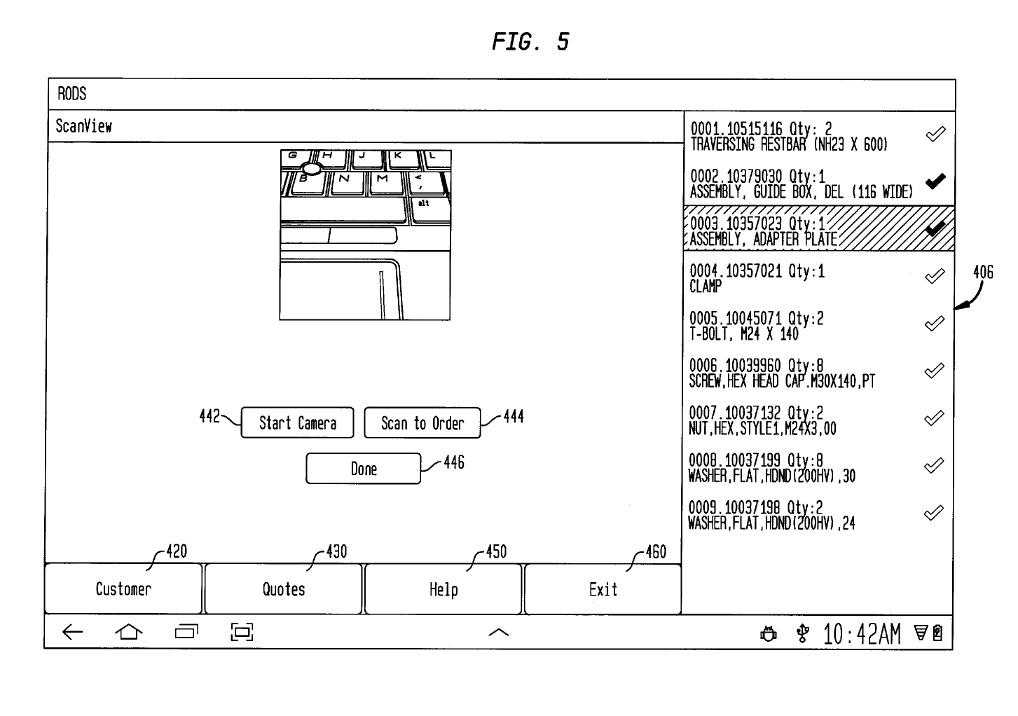

Another button or two on the panel 404 of the main screen can be “Quotes” or “Orders” 430 (FIGS. 2-3 show “Quotes”). For many, it can be labeled “Quotes” but for customers who have agreements that allow entry of pricing information into the parts database, this can say “Orders.” When the user selects the Quotes/Orders button 430, a new menu can appear at the bottom of the program where the user can select among other things: New Quote 432, Add to Quote 434, Scan to Quote 436, or Request Quote 438 (see FIG. 4). Selecting “New Quote/Order” 432 can clear the current quote/order being compiled so a new one can be started. By selecting “Add to Quote/Order” 434, this can add all selected parts in the bill of materials view to the current quote or order. A part in the bill of materials can be selected by selecting once on the upper left corner of the checkbox for that part so that the checkbox fills in. More than one part can be in the selected state at one time for adding to a quote or order. Selecting “Scan to Quote” 436 can permit the user to scan a code using the tablet's camera (see FIG. 5). This code can be a QR code, bar code, or like device that can be read with a camera or scanning device. When the user selects “Scan to Quote” 436, the drawing view can change to the scan view. In this scan view, the user can select “Start Camera” 442 to bring up the camera window. Once the code is centered in the camera window, the user can then select “Scan to Order” 444. If successful, the part number and description can be displayed, along with a message that the part has been added to the quote/order. If, on other hand, the scan is successful, but the part is not found in the database, an error message can notify the user that the part is not valid. If the scan is unsuccessful, a message can appear that informs the user that is was not successful and they can try to scan the code again. The user can continue to scan codes until they have added all the desired parts. Once finished scanning the user can select the “Done” button 446 on the scan view to return to the drawing view.

Another button in the Quotes/Orders menu is Request Quote/Order 438. When the user selects Request Quote/Order 438, the user may be prompted to select the e-mail account to use, and then the e-mail application can be launched. The “To,” “From,” and “Subject” fields can be populated, and the body of the e-mail is filled from the current request for quote or order. The user may edit the request or order before sending the e-mail. Once the e-mail is either sent or discarded, the user may be returned to the main screen of the application.

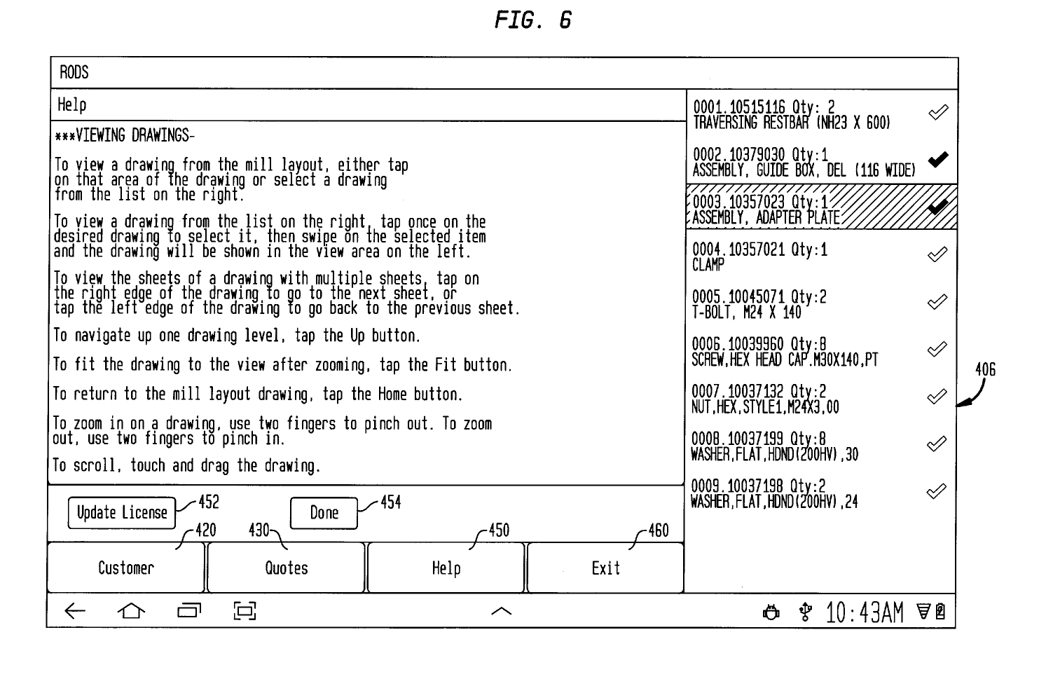

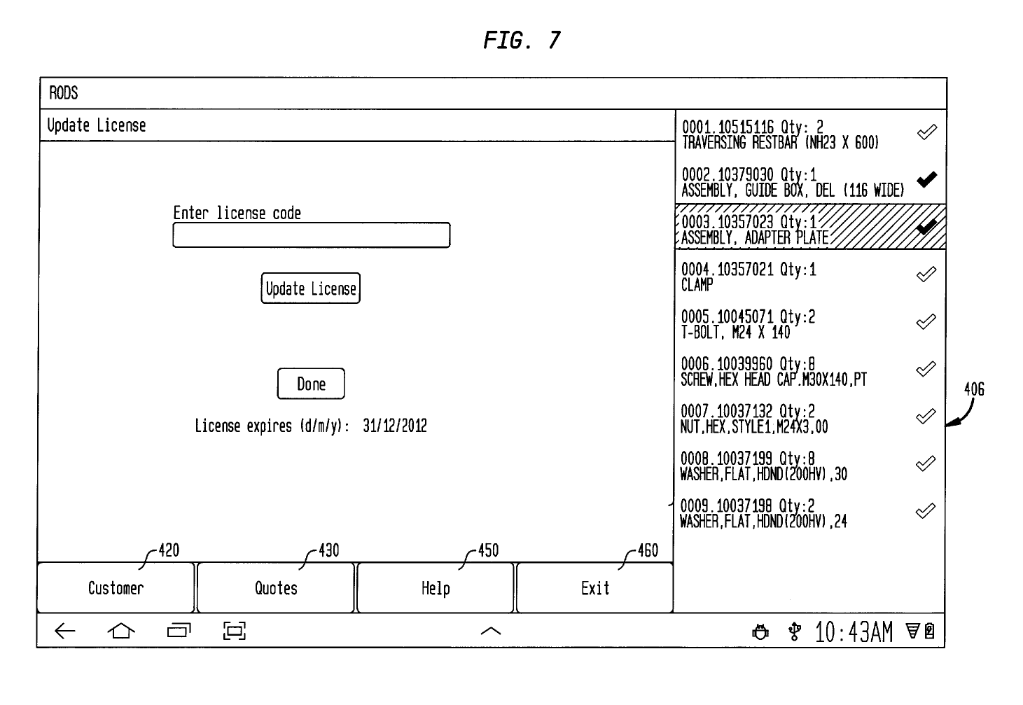

In the panel of the main screen, another available button is “Help” 450. The help screen can provide information on how to use the application, as well as allows the user to enter a new license if their previous license is about to expire. When the user first enters the help function, the upper left panel of the main screen can become the Help view (see FIG. 6). The top area of the screen can display help information. Below the help information are another plurality of buttons—“Update License” 452 and “Done” 454. When the user selects “Update License” 452, the Help view can go away and become the Update License view (see FIG. 7). Here, the user can enter the new license code and select “Update License” to write the new license to the local database. This view also displays the current expiration date. If the current license is not valid, a message that the license is invalid can be displayed here, and also on the drawing view (in place of the drawing). When the user is finished entering the license, they can select “Done” 454 to return to the drawing view of the main screen.

Another button in the panel of the main screen is the “Exit” button 460. This will exit the program and terminate the running application (rather than just suspend it).

In certain exemplary embodiments, aspects of the program may use of some open source libraries. For example and without limitation, the Adobe Flex SDK can provide functionality for creating a mobile application and Adobe Air is the runtime in which the application executes; and the ZXing library for the bar code scanning. Both are free to use under Apache licensing.

A system adapted to request or quote or process an item order request, the system comprising: a first database stored with drawings of at least one machine; a second database stored with customer data; and a user interface providing access to the first database adapted for a user to select from a drawing an item to be ordered and then providing access to the second database to either store or select customer data. In an exemplary embodiment, the system can be maintained and used on a tablet. In an exemplary embodiment, the system can be maintained and used on a hand-held device.

In an exemplary embodiment, the machine of the first database can be a rolling mill machine and the first database can comprise each spare item of the machine, whereby enabling selection of one or more spare item of the machine to be ordered for replacement. The system may also include a confirmation system that is adapted to ensure access to the first database only if a predetermined flag is set, e.g., the customer is not a confirmed licensee. Accordingly, the confirmation system can prohibit access to the first database if the customer is not a confirmed licensee.

In an exemplary embodiment, the customer data of the second database can comprise customer contact information.

The system may also include a scanning system that may be adapted to interpret a scanned code. For example and without limitation, the scanning system may comprise a QR code reader or a bar code reader.

A method of requesting a quotation or ordering an item for a rolling mill, the method comprising: providing a first database with drawings of at least one machine; providing a second database adapted to store customer data; and providing a user interface for access to the first database adapted for a user to select an item to be quoted or ordered from a drawing of at least one machine and then access to the second database for entering or selecting customer data.

In this method, the machine of the first database can be a rolling mill machine and the first database can comprise each spare item of the machine, whereby enabling selection of one or more spare item of the machine to be ordered for replacement.

The method can further comprise providing a confirmation system adapted to ensure access to the first database only if a predetermined flag is set. This confirmation system can prohibit access to the first database if the customer is not a confirmed licensee.

The method can also further comprise providing a scanning system adapted to interpret a scanned code. For example and without limitation, the scanning system can include a QR code reader or a bar code reader.

While embodiments of the present invention have been disclosed in exemplary forms, it will be apparent to those skilled in the art that many modifications, additions, and deletions can be made therein without departing from the spirit and scope of the invention and its equivalents, as set forth in the following claims.

What is claimed is:

1. A system adapted to request a quote or process an item order request, the system comprising:
a first database stored with drawings of at least one machine;
a second database stored with customer data; and
a user interface providing access to the first database adapted for a user to select from a drawing an item to be ordered and then providing access to the second database to either store or select customer data.

2. A tablet comprising the system of claim 1.

3. A handheld device comprising the system of claim 1.

4. The system of claim 1, the machine of the first database being a rolling mill machine and the first database comprising each spare item of the machine, enabling selection of one or more spare item of the machine to be ordered for replacement.

5. The system of claim 1, further comprising a confirmation system adapted to ensure access to the first database only if a predetermined flag is set.

6. The system of claim 5, the confirmation system prohibiting access to the first database if the customer is no longer a confirmed licensee.

7. The system of claim 1, the customer data of the second database comprising customer contact information.

8. The system of claim 1, further comprising a scanning system adapted to interpret a scanned code.

9. The system of claim 8, the scanning system comprising a QR code reader or a bar code reader.

10. A method of requesting a quotation or ordering an item for a rolling mill, the method comprising:
providing a first database with drawings of at least one machine;
providing a second database adapted to store customer data; and
providing a user interface for access to the first database adapted for a user to select an item to be quoted or ordered from a drawing of at least one machine and then access to the second database for entering or selecting customer data.

11. The method of claim 10, the machine of the first database being a rolling mill machine and the first database comprising each spare item of the machine, enabling selection of one or more spare item of the machine to be ordered for replacement.

12. The method of claim 10, further comprising: providing a confirmation system adapted to ensure access to the first database only if a predetermined flag is set.

13. The method of claim 12, the confirmation system prohibiting access to the first database if the customer is no longer a confirmed licensee.

14. The method of claim 10, further comprising: providing a scanning system adapted to interpret a scanned code.

15. The method of claim 8, the scanning system comprising a QR code reader or a bar code reader.
